(19) United States
(12) Patent Application Publication
(10) Pub. No.: US 2026/0187256 A1
(43) Pub. Date: Jul. 2, 2026

(54) TEXT ENCRYPTION AND APPLICATION IN ADVERTISING

(71) Applicant: WordNovo LLC, Springboro, OH (US)

(72) Inventor: Matthew C. Morrise, Portland, OR (US)

(21) Appl. No.: 19/437,569

(22) Filed: Dec. 31, 2025

Related U.S. Application Data
(60) Provisional application No. 63/740,506, filed on Dec. 31, 2024.

(51) Int. Cl. G06F 21/60; G10L 15/26

(52) U.S. Cl. CPC G06F 21/602; G10L 15/26

(57) ABSTRACT

A weak encryption process is provided for a given input. The process is carried out by receiving an input, generating encrypted output (e.g., an encrypted text), and outputting the encrypted output (e.g., encrypted text). The encrypted output is generated by classifying an element of the input to create a classification for the element, deriving a replacement element for the element based on the classification of the element, and replacing the element with the replacement element to generate the encrypted text.

### CROSS REFERENCE TO RELATED APPLICATIONS

This application claims the benefit of U.S. Provisional Patent Application Serial No. 63/740,506, filed December 31, 2024, by Morrise, having the title TEXT ENCRYPTION AND APPLICATION IN ADVERTISING, the disclosure of which is hereby incorporated herein by reference.

### BACKGROUND

### FIELD OF THE INVENTION

Various aspects disclosed herein, relate generally to the encryption of digital information such as text, through techniques that may include substitution, aggregation, cipher text generation, masking, obfuscation, etc.

### DESCRIPTION OF THE RELATED ART

The field of cryptography includes encryption technologies for transforming plaintext into a “ciphertext” that conceals the original or true meaning of the plaintext. Some encryption is designed to be reversable. Here, decryption is used to convert a ciphertext back to the original plaintext. Encryption schemes can take many forms from weak encryption to strong encryption. For example, in ancient times, a Caesar cipher shifted individual characters of a text by a fixed number of positions along the alphabet (if the shift is five, then A becomes F, B becomes G, C becomes H, etc.). In modern times, encryption technology has become increasingly more complex for applications such as privacy. However, there are applications for a wide range of encryption schemes that range from weak encryption to strong encryption.

### BRIEF SUMMARY

According to aspects of the present disclosure, a process for providing a weak encryption of an input comprises receiving an input and generating encrypted text based on the input. Here, the encrypted text is generated by classifying an element of the input to create a classification for the element, deriving a replacement element for the element based at least in part upon the classification of the element, and replacing the element with the replacement element to generate the encrypted text. The process further comprises outputting the encrypted text.

According to still further aspects of the present disclosure, a process for providing a weak encryption of an input comprises receiving an input, parsing the input to identify elements of the input, and generating encrypted text based on the input. Here, the encrypted text is generated by, for each identified element of the input, classifying the element of the input to create a classification for the element, determining a replacement element for the element based at least in part upon the classification of the element, and replacing the element with the replacement element to generate the encrypted text. The process further comprises outputting the encrypted text.

### BRIEF DESCRIPTION OF THE SEVERAL VIEWS OF THE DRAWINGS

FIG. 1A is a flow chart of a weak encryption scheme, according to various aspects herein;

FIG. 1B is an example system for carrying out the weak encryption scheme of FIG. 1A; and

FIGS. 2-5 are sample screenshots of a game that utilizes the encryption scheme of FIG. 1, according to various aspects herein.

### DETAILED DESCRIPTION

### Definitions

The following terms are defined as used herein.

An “input” is received data to be encrypted, where the data may be an electronic file containing text, audio, other digital information, or combinations thereof, to be converted to an encoded form, which may include for example, a digital representation of text. The data is stored in electronic form.

“Encrypted text” is a result of an encryption process where one or more elements of the input are replaced with one or more replacement elements.

An “element” of the input is a unit to be processed as a whole, such as a word or phrase identified in the input.

A “replacement element” is a replacement unit, such as a generated or otherwise derived word or phrase, that is substituted for an element of the input to create encrypted output.

### Introduction

According to aspects herein, an encryption process is provided that weakly encrypts digital information. As an example, digital representations of text (e.g., a word, phrase, etc.) can be digitally encrypted into a cipher. In some applications, the cipher is a coherent output. For instance, an input such as a digital representation of a word can be replaced by an encrypted text such as a generated or otherwise derived replacement word or replacement phrase. Likewise, an input such as a digital representation of a phrase can be encrypted into a coherent encrypted text output, such as a generated or otherwise derived word or phrase.

### Weak Encryption Example

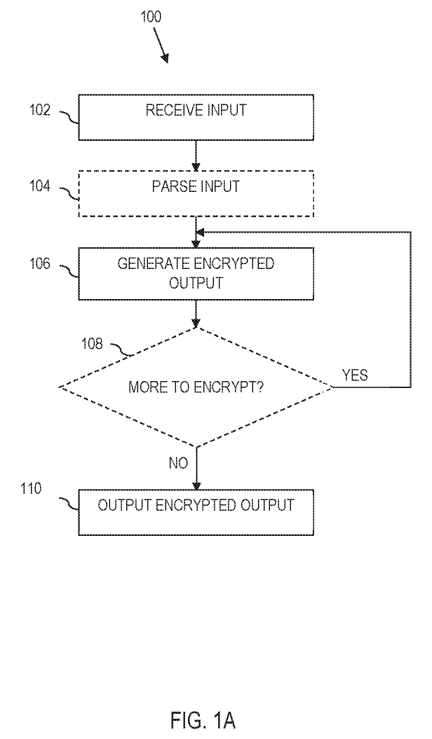

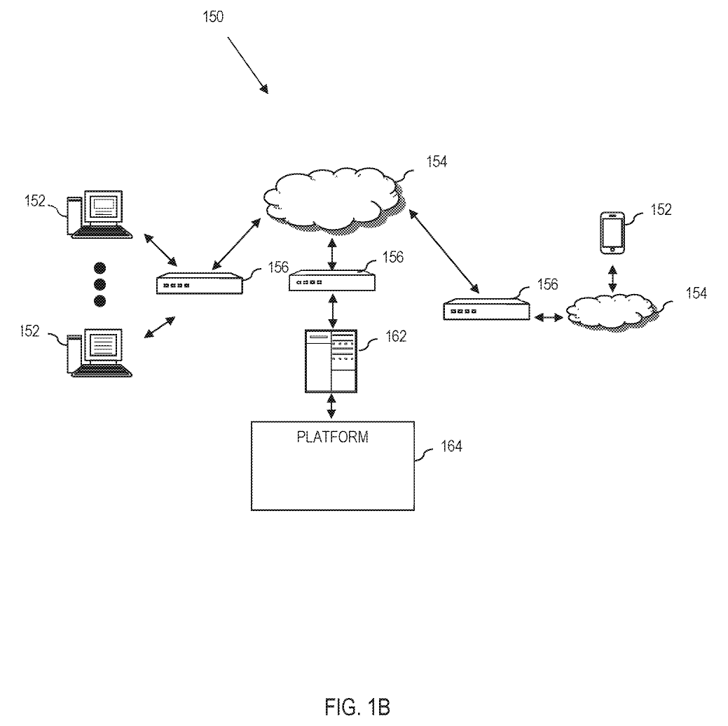

Referring now to the drawings, and in particular to FIG. 1A in combination with FIG. 1B, a process 100 for implementing the weak encryption is provided. The process 100 can be utilized for instance, to provide weak encryption to plaintext.

The process 100 comprises receiving an input at 102. Receiving an input at 102 can comprise for example, electronically receiving the input by a computer processing device. Here, the input can include one or more elements (e.g., text such as letters, a word, a phrase, a collection of words, a code, output of a speech-to-text converter, etc.). Here, the computer processing device can include a computer, a laptop, a server, a tablet, a smartphone, etc.

The input may be entered as text from an input/output device such as a keyboard. The input may be spoken and converted to text through a speech-to-text converter. The input may also be read from a file, extracted from a digital source, mined from a website on the Internet, or otherwise derived.

In some implementations, e.g., where the input includes non-alphabetic and/or non-numeric characters (e.g., punctuation, HTML tags, embedded markers, watermarks, etc.), such non-alphabetic and/or non-numeric characters can be left as-is. In some example implementations, each of the identified elements may be a single word (e.g., band), a set of words that represent a single representation (e.g., rock band), a phrase, etc.

Where the input comprises multiple distinct elements, e.g., text forming a phrase, a collection of words, etc., the process 100 can also optionally comprise parsing at 104, the input. For example, the computer processing device can electronically separate the input into individual elements. Here, one or more of the individual elements can be processed to derive an encrypted output as described more fully herein.

By way of non-limiting example, when receiving an input comprises receiving an input of more than one element, the process can further comprise parsing the input to identify elements of the input, wherein generating encrypted text based on the input comprises generating encrypted text based on the input by, for each identified element of the input, classifying the element of the input to create a classification for the element, determining a replacement element for the element based on the classification of the element, and replacing the element with the replacement element to generate the encrypted text.

As a further non-limiting example, classifying one or more of the elements of the input to create a classification for the element can comprise classifying the element as a skip word or a non-skip word, determining a replacement element for the element based on the classification of the element comprises determining a replacement element for the element based on the classification of the element only if the element is a non-skip word, and replacing the element with the replacement element to generate the encrypted text comprises determining a replacement element for the element based on the classification of the element only if the element is a non-skip word.

The process 100 also comprises generating, at 106, a replacement element, e.g., in the form of an encrypted output. For instance, where the input is a digital representation of a word or phrase, the output can comprise encrypted text.

As will be described in greater detail herein, in some embodiments, generating at 106, the replacement element (e.g., encrypted text) can comprise classifying an element of the input to create a classification for the element, deriving a replacement element for the element based at least in part upon the classification of the element, and replacing the element with the replacement element to generate the encrypted text.

As noted above, the replacement element may comprise a coherent output. For instance, an input such as a digital representation of a word can be replaced by an encrypted text such as a generated or otherwise derived replacement word or replacement phrase. That is, an element representing a word can be replaced by a different word or phrase. Likewise, an input such as a digital representation of a phrase can be encrypted into a coherent encrypted text output, such as a generated or otherwise derived word or phrase. That is, a phrase can be replaced by a different phrase (or word).

In some implementations, the computer processing device can automatically generate encrypted text that is similar to the source text. “Similar”, as used herein, means that the replacement element shares at least one definable association with the input element. The association can be a common attribute such as a part of speech (e.g., noun, pronoun, verb, adjective, adverb, preposition, conjunction, interjection, etc.). Here, it may be necessary to electronically and automatically derive context, either from other parts of an input, from external data sources, from intrinsic or extrinsic information available to the process, etc. The association can also be from defined attribute that defines a classifiable category (e.g., states, countries, teams, sports, or any other attribute that can be digitally classified).

In some implementations, the computer processing device can automatically generate encrypted text that is similar to the source text with word for word replacement. In some implementations, certain multi-word phrases can be treated as single words. For example, “New York” can be determined to be a U.S. state, thus triggering a replacement element having an association defined by a U.S. state, e.g., that is also a U.S. state (e.g., Oregon), or other geographic location that satisfies the association.

In some implementations, each replacement element can be automatically and/or electronically generated to reflect the same part of speech as the original word, so the encrypted text is grammatically similar to the source text. In such implementations, the elements must be classified. Classes may include parts of speech (e.g., noun, verb, adjective, etc.), specific context (e.g., geographic location, color elements, an element indicating an amount, etc.), skip words (e.g., articles (e.g., a, the, etc.), prepositions (e.g., of, in, etc.), other classifications, and combinations thereof. For example, “Oregon” and “New York” may be classified as nouns, U.S. states, and geographic locations. As another example, the word “run” may be classified as both a noun and a verb. The classifications for each element may be stored in metadata for that element.

Thus, the replacement element (word or phrase) for a classified element can be based, at least in part, on the classification. For example, if the element is “Oregon” and is classified as a U.S. state, then the process 100 may access a table of U.S. states and find “New Hampshire” as a replacement element for “Oregon”. As another example, if the element is “running” and classified as a gerund, then the process 100 may access a table of gerunds and find “painting” as a replacement element. As used herein, a “dictionary” is a group of the tables (or other ways of organizing) that include possible replacement words. In some embodiments, the replacement element is coherent. As used herein, “coherent” can mean logical or consistent to at least one degree. For instance, it may be enough that the replacement element is a valid English word (but not a nonsense collection of letters). It may also be that the replacement element is coherent in the context of grammar. For instance, a noun is replaced by a noun, a gerund is replaced by a gerund, etc. In still other examples, the coherent replacement element may be context coherent, where the replacement may change the perceived meaning of a sentence, but where the sentence still reads like a correctly structured sentence. For example, an element such as “blue” can be replaced with a replacement element "red”, and a sentence incorporating the original element will still read properly from a grammar standpoint, regardless of whether the new sentence makes sense to the reader.

In some implementations, such as where the input is a text such as a phrase, sentence, paragraph, passage, etc., some words may be parsed into elements that are considered “skip” elements. A skip element is where the replacement element is the same as the original element. Such may be the case for articles (e.g., a, an, the), or elements that could otherwise be transformed into a replacement element different from the original element, but are not. In this regard, using skip elements can mask the encryption process because it may be unclear what elements are transformed into different replacement elements, and what elements are original.

Further, the process 100 may also receive a key (e.g., a code) that guides the process during encryption. For instance, the process 100 may implemented such that receiving an input further comprises receiving a key, and determining a replacement element for the element based on the classification of the element comprises determining a replacement element for the element based on the classification of the element and based on the key.

The key may be a word (e.g., hotdog, space, diamond, etc.) or collection of alphanumeric characters that is used to select the replacement element from the table identified during classification. Other considerations may also be used in selecting the replacement word (e.g., position in the input, if there are multiple instances of the element, metadata tags, etc.). For example, a first instance of “New York” may be replaced with “Oregon” while a second instance within the same input text may be replaced by “West Virginia”. As another example, if the input includes a metadata tag for “Star Wars” to indicate that a Star Wars type dictionary should be used, then the geographical names may be replaced with places from Star Wars instead of U.S. states or other real geographical names. Thus, using the same key, a specific element instance will be replaced with the same replacement element for the same received input. Thus, the encryption is deterministic and will always result in the same output given the same input. However, if the key is changed, then a different (repeatable) replacement element will be identified for that same element.

In some implementations, the process 100 is implemented such that when encrypted text is processed using the same key the result is the unencrypted original text.

In some implementations, a select element of an input can be identified as the key. As an example, the first word in the input is identified as the key. As another example, the last word in the input is identified as the key.

As noted more fully herein, in certain implementations, any elements classified as ‘skip words’ are not replaced with a replacement element. In other words, the skip words are the same in the input and in the encrypted result.

As discussed above, an element may be classified in as multiple parts of speech (e.g., “run” as both a noun and a verb). Thus, context within the input could aid the process on which part of speech (or other classification) to use for the element.

In various embodiments, e.g., where generating at 106 comprises classifying an element of the input to create a classification for the element, the process 100 can comprise classifying the element of the input to create a classification for the element comprises classifying the element based on a dictionary. Here, generating encrypted text based on the input may also optionally further include appending an indication of a dictionary used for generating the encrypted text.

For instance, at least one specific electronic “dictionary” can be utilized. For instance, a dictionary may be a word dictionary in a specific language (e.g., English, French, Spanish, Japanese, Korean, etc.), that may be used when classifying and determining replacement elements. Additional dictionaries can also/alternatively be used (e.g., scientific dictionaries, technical dictionaries, slang dictionaries, custom dictionaries, etc.). Thus, elements in a dictionary have a type, where a type can be a language or other structure of a dictionary (e.g., fantasy, sci-fi, specific properties, technical, slang, etc.). For example, a first set of entries in a dictionary may be of an English type and a second set of entries in the dictionary may be of a German type, so English elements in the input would be replaced by German elements (and vice-versa). Note that this is not a translation, because the replacement element could be the same part of speech but not have the same meaning (e.g., “run” (which is “laufen” in German) could be replaced with “fliegen” (which is “fly” in English)).

Each word in a utilized dictionary can be tagged with its part of speech or classification. For example ‘run’ could be classified as verb+noun. Run can also be classified as an activity, exercise, etc. In some implementations, there can be different versions of a selected dictionary, where an element such as a last word of swapped text may be used if desired to specify which dictionary was used (e.g., to aid in decryption).

In numerous embodiments, the key may be used with the specific dictionary when determining replacement elements. For example, if the key is “space”, then if an element is classified as a geographic location, then the replacement element may be a name of a planet.

The encryption mentioned above results in a weak encryption scheme and is not intended to safeguard information but is intended for slight obfuscation (e.g., non-critical purposes, light security, entertainment purposes, etc.).

At 108, if there are more elements that need encryption (i.e., non-skip elements), the process 100 loops back to replace another element.

At 110, once all of the non-skip elements of the input have been replaced, an output is provided of the entire replaced text. The output at 110 may be a digital representation of information such as text or text string, or the output may be run through a text-to-speech converter and be spoken words, etc.

In some implementations, the process 100 can generate one or more encrypted outputs for each element. For instance, the process 100 can generate alternative encryptions that can be aggregated into lists, selections, alternatives, etc. In this regard, deriving a replacement element for the element based at least in part upon the classification of the element comprises deriving a plurality of replacement elements based at least in part upon the classification of the element.

### Example Process

Another illustrative example of the process 100, for providing a weak encryption of an input, is provided below. Although certain features are described for sake of clarity, the below process can include any one or more features described above.

In general, the process can comprise receiving an input, parsing the input to identify elements of the input, generating encrypted text based on the input, and outputting the encrypted text. In some implementations, generating encrypted text based on the input can comprise, for each identified element of the input, classifying the element of the input to create a classification for the element, determining a replacement element for the element based at least in part upon the classification of the element, and replacing the element with the replacement element to generate the encrypted text.

As a few illustrative examples, receiving an input can comprise receiving a text input, converting speech into the input using a speech-to-text converter, or any other input as described more fully herein.

In some embodiments, classifying the element of the input to create a classification for the element can comprise classifying the element as a skip word or a non-skip word. Determining a replacement element for the element based on the classification of the element can comprise determining a replacement element for the element based on the classification of the element only if the element is a non-skip word. Replacing the element with the replacement element to generate the encrypted text can comprise determining a replacement element for the element based on the classification of the element only if the element is a non-skip word.

In some embodiments, receiving an input can further comprise receiving a key. Here, determining a replacement element for the element based on the classification of the element can comprise determining a replacement element for the element based on the classification of the element and based on the key.

In some embodiments, classifying the element of the input to create a classification for the element comprises classifying the element based on a dictionary. For instance, generating encrypted text based on the input can further include appending an indication of a dictionary used for generating the encrypted text.

### Example System for Carrying Out the Process 100

Referring briefly to FIG. 1B, a corresponding system 150 is provided. The system 150 is suitable for carrying out the process 100 of FIG. 1A, and all variations thereof. The illustrated system 150 is a special purpose (particular) computing environment that includes a plurality of hardware processing devices (designated generally by the reference 152) that are linked together by one or more network(s) (designated generally by the reference 154).

The network(s) 154 provides communications links between the various processing devices 152 and may be supported by networking components 156 that interconnect the processing devices 152, including for example, routers, hubs, firewalls, network interfaces, wired or wireless communications links and corresponding interconnections, cellular stations and corresponding cellular conversion technologies (e.g., to convert between cellular and TCP/IP, etc.). Moreover, the network(s) 154 may comprise connections using one or more intranets, extranets, local area networks (LAN), wide area networks (WAN), wireless networks (Wi-Fi), the Internet, including the world wide web, cellular and/or other arrangements for enabling communication between the processing devices 152, in either real time or otherwise (e.g., via time shifting, batch processing, etc.).

A processing device 152 can be implemented as a server, personal computer, laptop computer, netbook computer, and/or other device capable of communicating over the network 154. Other types of processing devices 152 include for example, personal data assistant (PDA) processors, palm computers, cellular devices including cellular mobile telephones and smart telephones, tablet computers, etc.

The illustrated system 150 also includes a processing device implemented as a server 162 (e.g., a web server, file server, and/or other processing device) that supports a platform 164. The platform 164 provides domain-level resources to the processes described herein.

The illustrated system 150 can be utilized to carry out the process in any practical manner. For instance, the platform 164 via the server 162 can receive the input from any source across the network 154, e.g., via fetching, mining, searching, receiving, etc. Moreover, the input can be entered, e.g., via a keyboard on any one or more of the processing device 154, and then communicated to the server 162. The platform 164 can then output the encrypted element(s) to one or more processing devices 152, examples of which are described more fully herein.

### Encryption

According to certain implementations herein, the electronic encryption can utilize a classifier and a dataset of encryption options. As discussed above, the system can include an electronic dictionary of words (e.g., stored in a database, spreadsheet, tables, datasets, or any other practical electronic format) with each word tagged with one or more metadata elements. For example, each word can be tagged with an identity of its part of speech, type of word that belongs to a unique subset which can be based for instance, on a genus / species or other relationship (e.g., a type of: color, state, country, planet, tool, job, etc.). Of course, other and/or alternative classifications can also be utilized.

For example (and using the process above), an input is received, and elements of the input are classified and an index for each element is determined. The index is a position of the element within the table. For example, if the element is “run” (appearing in the input at element number twelve) and “run” appears in the table at element thirty-seven, then the index for “run” is thirty-seven.

Based on a key (and optionally a position of the element in the input), an offset is calculated. In some embodiments, the offset is forced to be an odd number. For elements with an odd index, the offset is added to the index to determine which element from an appropriate dictionary (or single table) is to be used as the replacement element for that element. For elements with an even index, the offset is subtracted from the index to determine which element from an appropriate dictionary (or single table) is to be used as the replacement element for that element. In cases where the result of the offset and index is greater than an amount of words in the corresponding table, a modulo operation is used to get a usable number (e.g., if the index is thirteen and the offset is eleven, the result is twenty-four, so if there are only ten words in the corresponding table, the result is the fourth element (24 mod 10 = 4). In many embodiments, if the original element is not found in the dictionary, then that element is determined to be a “skip” element as discussed above.

To decrypt the replacement word, the same process is used. For example, the same offset will be calculated from the key (and optionally the position of the element), and the index for the replacement word is used. Adding or subtracting an odd offset will always flip an even index to odd and vice-versa. Therefore, when applying the process above to the encrypted output, an element that had the offset added to the index of the original element will now have the offset subtracted from the replacement-element index, to provide the original element’s index. Note that in order to keep the rule of the index flipping odd to even and vice-versa, the number of element is a table must be even (or the modulo operation may flip it back, which would not allow for the same process to be used for encrypting and decrypting without extra steps).

As another example of an encryption algorithm, instead of the odd/even in conjunction with the offset, an exclusive-or (XOR) function can be used with the key and the index, which is also a reversible process. As such, any function where f(x) = y and f(y) = x may be used to encrypt the input.

### Example Use of Weak Encryption

The process 100 described above may be used in a game. An input text string (e.g., a famous quote, a poem, song lyrics, etc.) is encrypted using the process above to create an encrypted text, where a key is used to in the encryption. The object of the game is for a user to guess the key based on decrypting the encrypted text.

For example, the process 100 processes the following input: “Living is like tearing through a museum. Not until later do you really start absorbing what you saw, thinking about it, looking it up in a book, and remembering – because you can’t take it all in at once.” The encrypted output recites: “Praying is like acknowledging through a cottage. Not until thicker do you pressingly sign warning how you choose, voiding about it, leaning it west in a mit, and observing – because you shall not design it more in an overnight.”

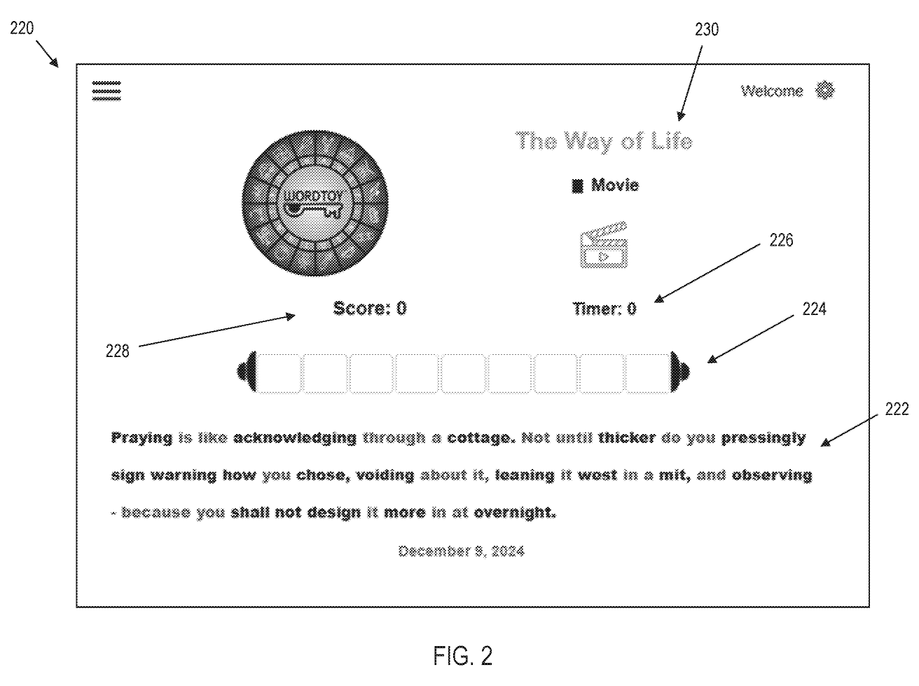

Turning to FIG. 2, the encrypted quote is displayed to the user via a graphical-user interface (GUI) 220, where the encrypted quote 222 is shown at a bottom of the GUI 220. A set of boxes 224 is displayed for a user to guess the key, where the number of boxes is equivalent to the number of characters in the key. Further, the GUI 220 includes a timer 226, a score 228, and a category 230 of the unencrypted text.

As indicated above, the object of the game is for the user to guess the key. However, by decrypting the encrypted text 222, the user receives letters of the key. In the encrypted text 222, any elements that are not encrypted (e.g., were never encrypted because they were skip words, have been decrypted correctly by the user, etc.) are displayed with an indication (e.g., a specific color (e.g., gray in FIG. 2), a marking (e.g., underlining), etc.) that they are not encrypted. On the other hand, encrypted elements are displayed with different indications (e.g., the color black in FIG. 2). In some embodiments, the key is a person to whom the encrypted quote 222 is attributed.

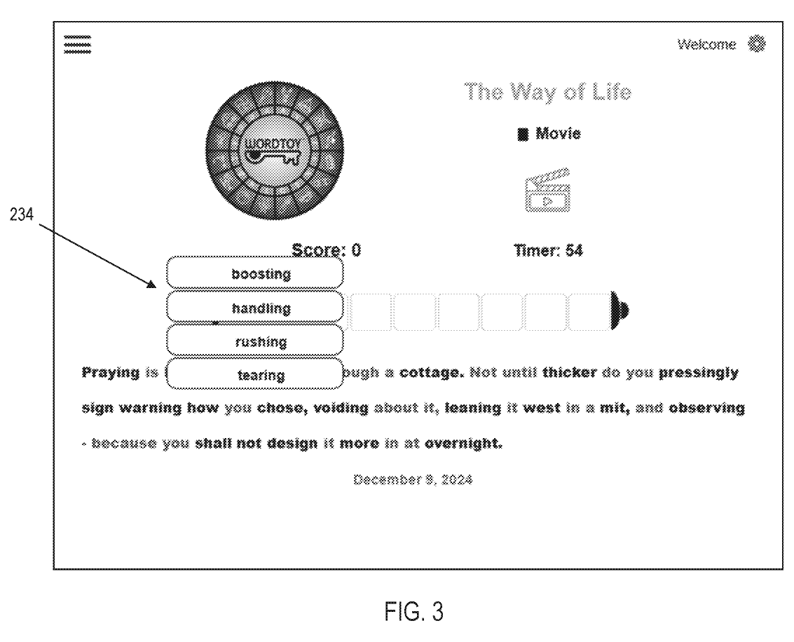

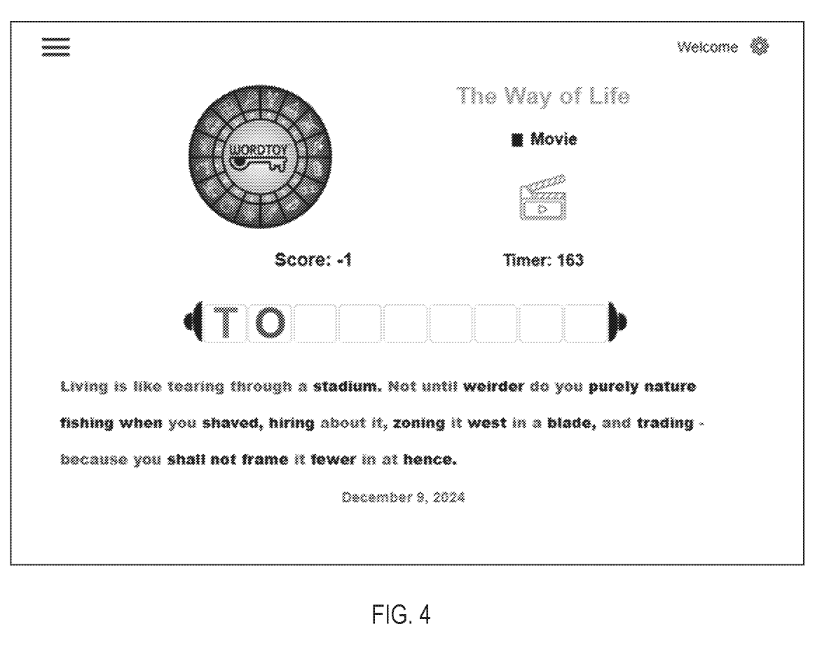

Turning to FIG. 3, when the user clicks on an encrypted element, a list 234 of options for the user to select is shown. The list is dynamic and populated with choices that were not used when the element was encrypted and with the non-encrypted element. For example, the fourth word in the encrypted text 222 is “acknowledging” (see FIG. 2), and as indicated above, the fourth word of the input is “tearing”. Therefore, one of the options in the list is “tearing” and three other words that could have been used during encryption (e.g., three other words from a gerund table). The user selects one of the choices, and if the choice is correct one of the boxes of the key may auto-populate with a correct character (shown in gray as “O”), as shown in the second box in FIG. 4. Note that in FIG. 4, the user has also entered a guess directly in the first box of the key, and the guess (T) was incorrect and shown in lighter gray.

If the user’s selection from the list is incorrect, then the incorrect selection may be shown with yet a third type of indication (e.g., italics, a different color, etc.), and the selection is removed from the list. A user only has a limited number of selections for each element (e.g., the number of items in the list minus one, a fixed number, etc.), so if the user runs out of selections for the element, the element may be shown with a fourth type of indication (e.g., strikethrough, “redacted” box, red color, etc.).

As discussed above, when the user decrypts an element correctly, a character of the key may be displayed. For example, when the user decrypts a first element, then a first random character of the key is displayed. When the user decrypts a second element, nothing happens with the key, but when the user decrypts a third element, then a second random character of the key is displayed. Thus, not every successful decryption of an element results in a character of the key being displayed.

In some embodiments, the number of options in the list is dynamic. For example, the number of options in the list may be proportional to the number of elements successfully decrypted by the user.

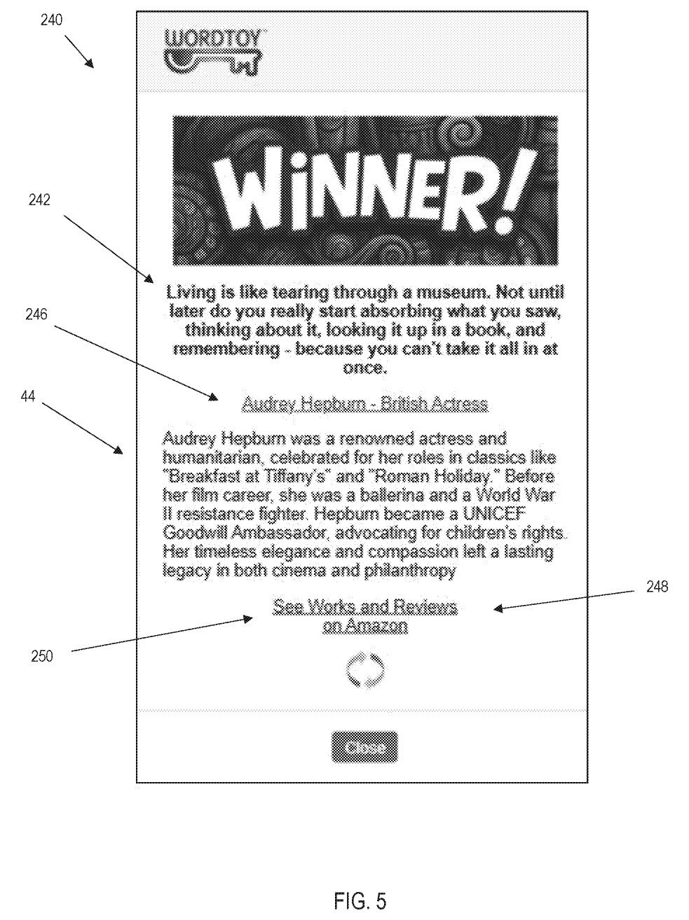

When the key is successfully solved, then a victory screen 240 is displayed, as shown in FIG. 5. The victory screen can display information such as information about the input or the person to whom the input is attributed 242; information about a subject of the input 244; a link to more information about the subject of the input 246; a link to products to purchase based on the input, the subject of the input, or both 248; a link to reviews about the input, subject of the input, products associated with the input 250, or combinations thereof; and other things. The products at the link may be recommended by any recommendation engine that takes into account the input, the subject of the input, or both (e.g., Audrey Hepburn movies for the example of FIG. 5). In some embodiments, the victory screen 240 includes an image associated with

In various embodiments, a successfully guessed key may be used by the user (e.g., via an extension in a web browser) on other websites to decrypt other information that has been encrypted using the process 100 above.

### Miscellaneous

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable storage medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM), Flash memory, an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device. A computer storage medium does not include propagating signals.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object-oriented programming language such as Java, Smalltalk, C++ or the like and conventional procedural programming languages, such as the "C" programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Network using a Network Service Provider).

Aspects of the present disclosure are described herein with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms "a", "an" and "the" are intended to include the plural forms as well, unless the context clearly indicates otherwise. It will be further understood that the terms "comprises" and/or "comprising," when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the invention in the form disclosed. Many modifications and variations will be apparent to those of ordinary skill in the art without departing from the scope and spirit of the invention. Aspects of the disclosure were chosen and described in order to best explain the principles of the invention and the practical application, and to enable others of ordinary skill in the art to understand the invention for various embodiments with various modifications as are suited to the particular use contemplated.

What is claimed is:

1. A process for providing a weak encryption of an input, the process comprising:
receiving an input;
generating encrypted text based on the input by:
classifying an element of the input to create a classification for the element;
deriving a replacement element for the element based on the classification of the element; and
replacing the element with the replacement element to generate the encrypted text; and
outputting the encrypted text.

2. The process of claim 1, wherein receiving an input comprises receiving a text input.

3. The process of claim 1, wherein receiving an input comprises converting speech into the input using a speech-to-text converter.

4. The process of claim 1, wherein receiving an input comprises receiving an input of more than one element, and
the process further comprises:
parsing the input to identify elements of the input;
wherein generating encrypted text based on the input comprises:
generating encrypted text based on the input by, for each identified element of the input:
classifying the element of the input to create a classification for the element;
determining a replacement element for the element based on the classification of the element;
replacing the element with the replacement element to generate the encrypted text.

5. The process of claim 4, wherein:
classifying the element of the input to create a classification for the element comprises classifying the element as a skip word or a non-skip word;
determining a replacement element for the element based on the classification of the element comprises determining a replacement element for the element based on the classification of the element only if the element is a non-skip word; and
replacing the element with the replacement element to generate the encrypted text comprises determining a replacement element for the element based on the classification of the element only if the element is a non-skip word.

6. The process of claim 1, wherein:
receiving an input further comprises receiving a key; and
determining a replacement element for the element based on the classification of the element comprises determining a replacement element for the element based on the classification of the element and based on the key.

7. The process of claim 1, wherein
classifying the element of the input to create a classification for the element comprises classifying the element based on a dictionary.

8. The process of claim 7, wherein generating encrypted text based on the input further includes appending an indication of a dictionary used for generating the encrypted text.

9. The process of claim 1, wherein:
deriving a replacement element for the element based at least in part upon the classification of the element comprises deriving a plurality of replacement elements based at least in part upon the classification of the element.

10. The process of claim 1, wherein deriving a replacement element for the element based on the classification of the element comprises:
calculating an offset based on the key;
applying the offset to an index of the element of the input within a dictionary to determine an index for the replacement element; and
selecting an element within the dictionary associated with the index for the replacement element.

11. The process of claim 10, wherein applying the offset to an index of the element of the input comprises:
forcing the offset to be odd;
subtracting the offset from the index if the index is even; and
adding the offset to the index if the index is odd.

12. The process of claim 1, wherein deriving a replacement element for the element based on the classification of the element comprises using a reversible function to derive the replacement element such that decryption uses the same function as the reversible function to encrypt.

13. A process for providing a weak encryption of an input, the process comprising:
receiving an input;
parsing the input to identify elements of the input;
generating encrypted text based on the input by, for each identified element of the input:
classifying the element of the input to create a classification for the element;
determining a replacement element for the element based at least in part upon the classification of the element; and
replacing the element with the replacement element to generate the encrypted text; and
outputting the encrypted text.

14. The process of claim 13, wherein:
classifying the element of the input to create a classification for the element comprises classifying the element as a skip word or a non-skip word;
determining a replacement element for the element based on the classification of the element comprises determining a replacement element for the element based on the classification of the element only if the element is a non-skip word; and
replacing the element with the replacement element to generate the encrypted text comprises determining a replacement element for the element based on the classification of the element only if the element is a non-skip word.

15. The process of claim 13, wherein:
receiving an input further comprises receiving a key; and
determining a replacement element for the element based on the classification of the element comprises determining a replacement element for the element based on the classification of the element and based on the key.

16. The process of claim 13, wherein
classifying the element of the input to create a classification for the element comprises classifying the element based on a dictionary.

17. The process of claim 16, wherein generating encrypted text based on the input further includes appending an indication of a dictionary used for generating the encrypted text.

18. The process of claim 13, wherein deriving a replacement element for the element based on the classification of the element comprises:
calculating an offset based on the key;
applying the offset to an index of the element of the input within a dictionary to determine an index for the replacement element; and
selecting an element within the dictionary associated with the index for the replacement element.

19. The process of claim 18, wherein applying the offset to an index of the element of the input comprises:
forcing the offset to be odd;
subtracting the offset from the index if the index is even; and
adding the offset to the index if the index is odd.

20. The process of claim 13, wherein deriving a replacement element for the element based on the classification of the element comprises using a reversible function to derive the replacement element such that decryption uses the same function as the reversible function to encrypt.
